(19) United States
(12) Patent Application Publication
(10) Pub. No.: US 2023/0142273 A1
(43) Pub. Date: May 11, 2023

(54) LIQUID ELECTROPHOTOGRAPHIC INK COMPOSITIONS

(71) Applicant: HEWLETT-PACKARD DEVELOPMENT COMPANY, L.P., Spring, TX (US)

(72) Inventors: Rajesh Kelekar, Palo Alto, CA (US); Omer Gila, Palo Alto, CA (US)

(21) Appl. No.: 17/915,967

(22) PCT Filed: Sep. 25, 2020
(86) PCT No.: PCT/US2020/052719

§ 371 Date: Sep. 29, 2022

(51) Int. Cl. C09D 11/033; C09D 11/06; C09D 11/52

(52) U.S. Cl. CPC C09D 11/033; C09D 11/06; C09D 11/52

(57) ABSTRACT

Described herein is a liquid electrophotographic ink composition comprising chargeable particles comprising a thermoplastic resin; and a carrier liquid produced from vegetable oil or animal fat, the carrier liquid comprising an aliphatic hydrocarbon, an ester of a fatty acid and a monoalcohol, or a mixture thereof. Also described herein is a process for producing the liquid electrophoto-graphic ink composition and a liquid electrophoto-graphic printing process.

Electrophotographic printing processes can involve creating an image on a photoconductive surface, applying an ink having charged particles to the photoconductive surface, such that they selectively bind to the image, and then transferring the charged particles in the form of the image to a substrate.

The photoconductive surface may be on a cylinder and may be termed a photo imaging plate (PIP). The photoconductive surface is selectively charged with a latent electrophotographic image having image and background areas with different potentials. For example, an electrophotographic ink composition comprising charged toner particles in a carrier liquid can be brought into contact with the selectively charged photoconductive surface. The charged toner particles adhere to the image areas of the latent image while the background areas remain clean. The image is then transferred to a substrate directly or, more commonly, by being first transferred to an intermediate transfer member, which can be a soft swelling blanket, and then to the substrate.

### BRIEF DESCRIPTION OF THE FIGURES

FIG. 1 is a schematic representation of a liquid electrophotographic (LEP) printer.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a paper or a plastic substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing in which a liquid composition is employed in the electrophotographic process rather than a powder toner. An electrostatic printing process may involve subjecting the electrostatic composition to an electric field, for example, an electric field having a field gradient of 50-400 V/µm, or more, in some examples, 600-900 V/µm, or more.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt.% to about 5 wt.%” should be interpreted to include not just the explicitly recited values of about 1 wt.% to about 5 wt.%, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt.% values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a liquid electrophotographic ink composition. The liquid electrophotographic ink composition may comprise:
chargeable particles comprising a thermoplastic resin; and
a carrier liquid produced from vegetable oil or animal fat, the carrier liquid comprising an aliphatic hydrocarbon, an ester of a fatty acid and a monoalcohol or a mixture thereof.

In another aspect, there is provided a process for producing a liquid electrophotographic ink composition. The process for producing a liquid electrophotographic ink composition may comprise:

dispersing chargeable particles comprising a thermoplastic resin in a carrier liquid wherein the carrier liquid has been produced from vegetable oil or animal fat and comprises an aliphatic hydrocarbon, an ester of a fatty acid and a monoalcohol or a mixture thereof.

In a further aspect, there is provided a liquid electrophotographic printing process. The liquid electrophotographic printing process may comprise:

electrophotographically printing a liquid electrophotographic ink composition comprising chargeable particles comprising a thermoplastic resin; and a carrier liquid produced from vegetable oil or animal fat, the carrier liquid comprising an aliphatic hydrocarbon, an ester of a fatty acid and a monoalcohol or a mixture thereof.

Currently, liquid electrophotographic (LEP) ink compositions generally contain a carrier liquid comprising a mixture of isoparaffinic hydrocarbons derived from petroleum. Because such compositions are derived from petroleum, they contain impurities, including aromatic compounds that, above certain limits, are known or suspected to be hazardous to human health (e.g., benzene and naphthalene). For LEP printing, the carrier liquid affects numerous printing metrics, including the lifespan of the ink composition, the lifespan of the components of the printer, the quality of the images obtained, the adhesion of the ink to the print medium, the transfer efficiency of ink through the printer and the drying of printed images.

The incorporation into LEP ink compositions of carrier liquids producible from vegetable oil or animal fat comprising aliphatic hydrocarbons and/or esters of a fatty acid and a monoalcohol has been found to avoid or at least mitigate at least one of these difficulties. These carrier liquids contain much lower amounts of aromatic compounds. Moreover, these carrier liquids are derived from renewable resources.

### Liquid Electrophotographic Ink Compositions

In an aspect, there is provided a liquid electrophotographic ink composition. The liquid electrophotographic ink composition may comprise chargeable particles comprising a thermoplastic resin; and a carrier liquid producible from vegetable oil or animal fat. The liquid electrophotographic ink composition may comprise chargeable particles comprising a thermoplastic resin; and a carrier liquid producible from vegetable oil or animal fat, the carrier liquid comprising an aliphatic hydrocarbon, an ester of a fatty acid and a monoalcohol or a mixture thereof. The liquid electrophotographic ink composition may comprise chargeable particles comprising a thermoplastic resin; and a carrier liquid comprising an aliphatic hydrocarbon, an ester of a fatty acid and a monoalcohol or a mixture thereof.

In some examples, the chargeable particles comprise a thermoplastic resin and a colorant. In some examples, the LEP ink composition comprises a carrier liquid and chargeable particles comprising a thermoplastic resin and a colorant.

In some examples, the LEP ink composition further comprises a charge adjuvant. In some examples, the LEP ink composition comprises a carrier liquid, chargeable particles and a charge adjuvant.

In some examples, the LEP ink composition further comprises a charge director. In some examples, the LEP ink composition comprises a carrier liquid, chargeable particles and a charge director. In some examples, the LEP ink composition further comprises a charge adjuvant and a charge director. In some examples, the LEP ink composition comprises a carrier liquid, chargeable particles, a charge adjuvant and a charge director.

In some examples, the LEP ink composition further comprises other additives. In some examples, the LEP ink composition comprises a carrier liquid, chargeable particles and additives. In some examples, the LEP ink composition further comprises a charge adjuvant and other additives. In some examples, the LEP ink composition comprises a carrier liquid, chargeable particles, a charge adjuvant and other additives. In some examples, the LEP ink composition further comprises a charge director and other additives. In some examples, the LEP ink composition comprises a carrier liquid, chargeable particles, a charge director and other additives. In some examples, the LEP ink composition further comprises a charge adjuvant, a charge director and other additives. In some examples, the LEP ink composition comprises a carrier liquid, chargeable particles, a charge adjuvant, a charge director and other additives.

### Carrier Liquid

In some examples, the carrier liquid comprises an aliphatic hydrocarbon, an ester of a fatty acid and a monoalcohol, or a mixture thereof. In some examples, the carrier liquid comprises an aliphatic hydrocarbon. In some examples, the carrier liquid comprises an ester of a fatty acid and a monoalcohol.

In some examples, the carrier liquid produced from vegetable oil or animal fat comprises an aliphatic hydrocarbon, an ester of a fatty acid and a monoalcohol or a mixture thereof. In some examples, the carrier liquid produced from vegetable oil comprises an aliphatic hydrocarbon, an ester of a fatty acid and a monoalcohol or a mixture thereof. In some examples, the carrier liquid produced from vegetable oil or animal fat comprises an aliphatic hydrocarbon. In some examples, the carrier liquid produced from vegetable oil comprises an aliphatic hydrocarbon. In some examples, the carrier liquid produced from vegetable oil or animal fat comprises an ester of a fatty acid and a monoalcohol. In some examples, the carrier liquid produced from vegetable oil comprises an ester of a fatty acid and a monoalcohol.

A carrier liquid produced from vegetable oil or animal fat can be distinguished from a carrier liquid derived from petroleum by using radiocarbon dating, which can be performed as described in ASTM D6866.

In some examples, the vegetable oil is selected from palm oil, coconut oil, soybean oil, rapeseed oil, coffee bean oil, sunflower oil, used cooking oil and mixtures thereof. In some examples, the animal fat may comprise tallow (e.g., beef tallow and pork tallow), pork lard and chicken fat. In some example, the vegetable oil is selected from palm oil and coconut oil. In some examples, the vegetable oil is palm oil. In some examples, the vegetable oil is coconut oil.

In some examples, the carrier liquid is an aliphatic hydrocarbon produced from vegetable oil by high pressure hydrogenation. In some examples, hydrodearomatization is performed on the aliphatic hydrocarbons.

In some examples, the carrier liquid is an ester of a fatty acid and a monoalcohol produced from vegetable oil or animal fat by transesterification, for example, supercritical fluid transesterification, acid-catalysed transesterification or enzyme-catalysed transesterification. In some examples, the carrier liquid is an ester of a fatty acid and a monoalcohol produced from vegetable oil by supercritical fluid transesterification, acid-catalysed transesterification or enzyme-catalysed transesterification. In some examples, the carrier liquid is an ester of a fatty acid and a monoalcohol produced from animal fat by supercritical fluid transesterification, acid-catalysed transesterification or enzyme-catalysed transesterification.

In some examples, at least 50 wt.% of the carrier liquid is producible from, for example, produced from, vegetable oil or animal fat, for example, at least 55 wt.%, at least 60 wt.%, at least 65 wt.%, at least 70 wt.%, at least 75 wt.%, at least 80 wt.%, at least 85 wt.%, at least 86 wt.%, at least 87 wt.%, at least 88 wt.%, at least 89 wt.%, at least 90 wt.%, at least 91 wt.%, at least 92 wt.%, at least 93 wt.%, at least 94 wt.%, at least 95 wt.%, or at least 99 wt.% of the carrier liquid is producible from, for example, produced from, vegetable oil or animal fat. In some examples, 100 wt.% of the carrier liquid is producible from, for example, produced from, vegetable oil or animal fat, for example, up to 99 wt.%, up to 98 wt.%, up to 97 wt.%, up to 96 wt.%, up to 95 wt.%, up to 94 wt.%, up to 93 wt.%, up to 92 wt.%, up to 91 wt.%, up to 90 wt.%, up to 89 wt.%, up to 88 wt.%, up to 87 wt.%, up to 86 wt.%, up to 85 wt.%, up to 80 wt.%, up to 75 wt.%, up to 70 wt.%, up to 65 wt.%, up to 60 wt.%, up to 55 wt.%, or up to 50 wt.% of the carrier liquid is producible from, for example, produced from, vegetable oil or animal fat. In some examples, from 50 wt.% to 100 wt.% of the carrier liquid is producible from, for example, produced from, vegetable oil or animal fat, for example, from 55 wt.% to 100 wt.%, 60 wt.% to 99 wt.%, 65 wt.% to 98 wt.%, 70 wt.% to 97 wt.%, 75 wt.% to 98 wt.%, 80 wt.% to 96 wt.%, 85 wt.% to 95 wt.%, 90 wt.% to 99 wt.%, 91 wt.% to 98 wt.%, 92 wt.% to 97 wt.%, 93 wt.% to 99 wt.%, 94 wt.% to 100 wt.% of the carrier liquid is producible from, for example, produced from, vegetable oil or animal fat.

In some examples, the carrier liquid comprises up to about 0.01 wt.% aromatic compounds, for example, up to about 0.009 wt.%, up to about 0.008 wt.%, up to about 0.007 wt.%, up to about 0.006 wt.%, or up to about 0.005 wt.% aromatic compounds. In some examples, the carrier liquid comprises from about 0 wt.% to about 0.01 wt.% aromatic compounds, for example, from about 0 wt.% to about 0.005 wt.% aromatic compounds.

In some examples, the carrier liquid may have a boiling point or lower limit of a boiling range of at least 150° C., for example, at least 160° C., at least 170° C., at least 180° C., at least 190° C., at least 200° C., at least 210° C., at least 220° C., at least 230° C., at least 240° C., at least 250° C., at least 260° C., at least 270° C., at least 280° C., at least 290° C., or at least 300° C. In some examples, the carrier liquid may have a boiling point or upper limit of a boiling range of up to 300° C., for example, up to 290° C., up to 280° C., up to 270° C., up to 260° C., up to 250° C., up to 240° C., up to 230° C., up to 220° C., up to 210° C., up to 200° C., up to 190° C., up to 180° C., up to 170° C., up to 160° C., or up to 150° C. In some examples, the carrier liquid may have a boiling point of from 150° C. to 300° C., for example, 160° C. to 290° C., 170° C. to 280° C., 180° C. to 270° C., 190° C. to 260° C., 200° C. to 250° C., 210° C. to 240° C., or 220° C. to 230° C. In some examples, the carrier liquid may have a boiling range within the range of from 150° C. to 300° C., for example, 160° C. to 290° C., 170° C. to 280° C., 180° C. to 270° C., 190° C. to 260° C., 200° C. to 250° C., 210° C. to 240° C., or 220° C. to 230° C. In some examples, the carrier liquid may be a mixture of components and have a boiling range that falls within the range specified herein. The boiling point or boiling range may be determined as described in ASTM D86. Boiling points or boiling ranges are measured at standard atmospheric pressure (101.3 kPa).

In several countries, for example, Canada, a compound with a boiling point of 250° C. or more is considered a non-volatile organic compound (non-VOC). In some examples, the carrier liquid is a non-volatile organic liquid with a boiling point or lower limit of a boiling range of 250° C. or more.

In some examples, the LEP ink composition comprises at least about 50 wt.% liquid carrier by total weight of the composition, for example, at least about 55 wt.%, at least about 60 wt.%, at least about 65 wt.%, at least about 70 wt.%, at least about 75 wt.%, at least about 80 wt.%, at least about 85 wt.%, at least about 90 wt.%, at least about 95 wt.%, at least about 96 wt.%, at least about 97 wt.%, at least about 98 wt.% or at least about 99 wt.% liquid carrier by total weight of the composition. In some examples, the LEP ink composition comprises up to about 99 wt.% liquid carrier by total weight of the composition, for example, up to about 98 wt.%, up to about 97 wt.%, up to about 96 wt.%, up to about 95 wt.%, up to about 90 wt.%, up to about 85 wt.%, up to about 80 wt.%, up to about 75 wt.%, up to about 70 wt.%, up to about 65 wt.%, up to about 60 wt.%, or up to about 55 wt.% liquid carrier by total weight of the composition. In some examples, the LEP ink composition comprises from about 55 wt.% to about 99 wt.% liquid carrier by total weight of the composition, for example, from about 60 wt.% to about 98 wt.%, about 65 wt.% to about 97 wt.%, about 70 wt.% to about 96 wt.%, about 75 wt.% to about 95 wt.%, about 80 wt.% to about 90 wt.%, about 85 wt.% to about 99 wt.% liquid carrier by total weight of the composition.

### Aliphatic Hydrocarbon

In some examples, the carrier liquid comprises an aliphatic hydrocarbon producible from vegetable oil or animal fat. In some examples, the carrier liquid comprises an aliphatic hydrocarbon producible from vegetable oil. In some examples, the carrier liquid comprises an aliphatic hydrocarbon produced from vegetable oil or animal fat. In some examples, the carrier liquid comprises an aliphatic hydrocarbon produced from vegetable oil.

In some example, the aliphatic hydrocarbon is selected from C5 to C25 aliphatic hydrocarbons and mixtures thereof. In some examples, the aliphatic hydrocarbon is selected from C10 to C25 aliphatic hydrocarbons and mixtures thereof, for example, C11 to C20 aliphatic hydrocarbons, C11 to C15 aliphatic hydrocarbons, C11 to C13 aliphatic hydrocarbons, C14 to C25 aliphatic hydrocarbons, C15 to C25 aliphatic hydrocarbons, C15 to C20 aliphatic hydrocarbons, C14 to C19 aliphatic hydrocarbons, C15 to C18 aliphatic hydrocarbons, C10 to C17 aliphatic hydrocarbons, C15 to C16 hydrocarbons and mixtures thereof.

In some examples, the aliphatic hydrocarbon comprises a mixture of aliphatic hydrocarbons. In some examples, the aliphatic hydrocarbon may comprise a mixture of aliphatic hydrocarbons with up to two different numbers of carbon atoms, for example, a mixture of C15 and C16 aliphatic hydrocarbons.

In some examples, the aliphatic hydrocarbon may comprise a straight chain aliphatic hydrocarbon, a branched chain aliphatic hydrocarbon, a cyclic aliphatic hydrocarbon, and mixtures thereof. In some examples, the aliphatic hydrocarbon comprises a mixture of straight chain aliphatic hydrocarbons, a mixture of branched chain aliphatic hydrocarbons, a mixture of cyclic aliphatic hydrocarbons, or mixtures thereof. In some examples, the aliphatic hydrocarbon comprises a mixture of branched chain aliphatic hydrocarbons.

In some examples, the aliphatic hydrocarbon may have a boiling point or lower limit of a boiling range of at least 175° C., for example, at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 247° C., at least 250° C., at least 255° C., at least 260° C., at least 265° C., at least 269° C., at least 270° C. or at least 275° C. In some examples, the aliphatic hydrocarbon may have a boiling point or upper limit of a boiling range of up to 300° C., for example, up to 295° C., up to 290° C., up to 285° C., up to 280° C., up to 275° C., up to 270° C., up to 269° C., up to 265° C., up to 260° C., up to 255° C., up to 247° C., up to 245° C., up to 240° C., up to 235° C., up to 230° C., up to 225° C., up to 220° C., up to 215° C., up to 210° C., up to 205° C., up to 200° C., up to 195° C., up to 190° C., up to 185° C., up to 180° C., or up to 175° C. In some examples, the aliphatic hydrocarbon may have a boiling point of from 175° C. to 300° C., for example, 180° C. to 295° C., 185° C. to 290° C., 190° C. to 285° C., 195° C. to 280° C., 200° C. to 275° C., 205° C. to 270° C., 210° C. to 265° C., 215° C. to 260° C., 220° C. to 255° C., 225° C. to 250° C., 230° C. to 295° C., 235° C. to 290° C., 240° C. to 285° C., 245° C. to 280° C., 247° C. to 269° C., 250° C. to 275° C., 255° C. to 270° C., or 260° C. to 265° C. In some examples, the aliphatic hydrocarbon may have a boiling range within the range of from 175° C. to 300° C., for example, 180° C. to 295° C., 185° C. to 290° C., 190° C. to 285° C., 195° C. to 280° C., 200° C. to 275° C., 205° C. to 270° C., 210° C. to 265° C., 215° C. to 260° C., 220° C. to 255° C., 225° C. to 250° C., 230° C. to 295° C., 235° C. to 290° C., 240° C. to 285° C., 245° C. to 280° C., 247° C. to 269° C., 250° C. to 275° C., 255° C. to 270° C., or 260° C. to 265° C.

### Ester of a Fatty Acid and a Monoalcohol

In some examples, the carrier liquid comprises an ester of a fatty acid and a monoalcohol. In some examples, the ester of a fatty acid and a monoalcohol may be producible from vegetable oil or animal fat. In some examples, the ester of a fatty acid and a monoalcohol may be producible from vegetable oil. In some examples, the carrier liquid comprises an ester of a fatty acid and a monoalcohol producible from vegetable oil or animal fat. In some examples, the carrier liquid comprises an ester of a fatty acid and a monoalcohol produced from vegetable oil or animal fat. In some examples, the carrier liquid comprises an ester of a fatty acid and a monoalcohol producible from vegetable oil. In some examples, the carrier liquid comprises an ester of a fatty acid and a monoalcohol produced from vegetable oil.

In some examples, the ester of a fatty acid and a monoalcohol is selected from C5 to C25 esters of a fatty acid and a monoalcohol and mixtures thereof. In some examples, the ester of a fatty acid and a monoalcohol is selected from C6 to C24 esters of a fatty acid and a monoalcohol, for example, C6 to C23, C7 to C22, C8 to C21, C8 to C10, C9 to C20, C10 to C19, C11 to C18, C12 to C17, C13 to C16, or C14 to C15 esters of a fatty acid and a monoalcohol. In some examples, the ester of a fatty acid and a monoalcohol is selected from C7, C8, C9, C10, C11, C12, C13, C14, C15, C16 and C17 esters of a fatty acid and a monoalcohol. In some examples the ester of a fatty acid and a monoalcohol is a mixture of esters.

In some examples, the monoalcohol is selected from C1 to C5 monoalcohols and mixtures thereof. In some examples, the monoalcohol is selected from methanol, ethanol, propanol, and isopropanol and mixtures thereof. In some examples, the monoalcohol is methanol or isopropanol. In some examples, the monoalcohol is methanol. In some examples, the monoalcohol is isopropanol.

In some examples, the fatty acid is selected from C5 to C24 fatty acids and mixtures thereof, for example, C6 to C23, C7 to C22, C8 to C21, C9 to C20, C10 to C19, C11 to C18, C12 to C17, C13 to C16, or C14 to C15 fatty acids and mixtures thereof. In some examples, the fatty acid is selected from C7, C8, C9, C10, C11, C12, C13, C14, C15, C16 fatty acids and mixtures thereof. In some examples, the fatty acid is selected from octanoate, decanoate, laurate and mixtures thereof.

In some examples, the ester of a fatty acid and a monoalcohol is an ester of any fatty acid mentioned herein and any monoalcohol mentioned herein. In some examples, the ester of a fatty acid and a monoalcohol is an ester of a fatty acid and methanol, ethanol or isopropanol. In some examples, the ester of a fatty acid and a monoalcohol is an ester of a fatty acid and methanol or isopropanol. In some examples, the ester of a fatty acid and a monoalcohol is an ester of a fatty acid and methanol. In some examples, the ester of a fatty acid and a monoalcohol is an ester of a fatty acid and isopropanol. In some examples, the ester of a fatty acid and a monoalcohol is an ester of a fatty acid and ethanol. In some examples, the ester of a fatty acid and a monoalcohol is selected from methyl octanoate, methyl nonanoate, methyl decanoate, isopropyl laurate, ethyl decanoate, and isopropyl decanoate. In some examples, the ester of a fatty acid and a monoalcohol is selected from methyl octanoate, methyl decanoate and isopropyl laurate.

In some examples, the ester of a fatty acid and a monoalcohol hydrocarbon may have a boiling point or lower limit of a boiling range of at least 150° C., for example, at least 155° C., at least 160° C., at least 165° C., at least 170° C., at least 175° C., at least 180° C., at least 185° C., at least 190° C., at least 193° C., at least 195° C., at least 200° C., at least 205° C., at least 210° C., at least 215° C., at least 220° C., at least 224° C., at least 225° C. at least 230° C., at least 235° C., at least 240° C., at least 245° C., at least 247° C., at least 250° C., at least 255° C., at least 260° C., at least 265° C., at least 269° C., at least 270° C., at least 275° C., at least 280° C., at least 281° C., at least 285° C., or at least 290° C. In some examples, the ester of a fatty acid and a monoalcohol hydrocarbon may have a boiling point or upper limit of a boiling range of up to 300° C., for example, up to 295° C., up to 290° C., up to 285° C., up to 280° C., up to 275° C., up to 270° C., up to 269° C., up to 265° C., up to 260° C., up to 255° C., up to 247° C., up to 245° C., up to 240° C., or up to 235° C. In some examples, the ester of a fatty acid and a monoalcohol hydrocarbon may have a boiling point of from 150° C. to 300° C., for example, 155° C. to 295° C., 160° C. to 285° C., 165° C. to 280° C., 170° C. to 275° C., 175° C. to 270° C., 180° C. to 265° C., 185° C. to 260° C., 190° C. to 255° C., 195° C. to 250° C., 200° C. to 245° C., 205° C. to 240° C., 210° C. to 235° C., 215° C. to 230° C., or 220° C. to 225° C.

### Chargeable Particles

The LEP ink composition may comprise chargeable particles comprising a thermoplastic resin. The chargeable particles may comprise a thermoplastic resin and a colorant. In some examples, the LEP ink composition comprises chargeable particles (i.e., having or capable of developing a charge, for example, in an electromagnetic field) including the thermoplastic resin and, in some examples, a colorant.

### Thermoplastic Resin

In some examples, the thermoplastic resin may comprise a thermoplastic polymer. The thermoplastic resin may be referred to herein as a resin. In some examples, the thermoplastic resin may comprise a polymer selected from ethylene acrylic acid copolymers; ethylene methacrylic acid copolymers; ethylene vinyl acetate copolymers; copolymers of ethylene (e.g. 80 wt.% to 99.9 wt.%), and alkyl (e.g. C1 to C5) ester of methacrylic or acrylic acid (e.g. 0.1 wt.% to 20 wt.%); copolymers of ethylene (e.g. 80 wt.% to 99.9 wt.%), acrylic or methacrylic acid (e.g. 0.1 wt.% to 20 wt.%) and alkyl (e.g. C1 to C5) ester of methacrylic or acrylic acid (e.g. 0.1 wt.% to 20 wt.%); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt.% to 90 wt.%)/methacrylic acid (e.g. 0 wt.% to 20 wt.%)/ethylhexylacrylate (e.g. 10 wt.% to 50 wt.%)); ethylene-acrylate terpolymers: ethylene-acrylic esters-maleic anhydride (MAH) or glycidyl methacrylate (GMA) terpolymers; ethylene-acrylic acid ionomers and combinations thereof.

The thermoplastic resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g, can be measured using standard procedures known in the art, for example, using the procedure described in ASTM D1386.

The thermoplastic resin may comprise a polymer having acidic side groups that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example, as described in ASTM D1238.

The thermoplastic resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the thermoplastic resin may comprise a copolymer of an alkylene monomer and a monomer selected from methacrylic acid and acrylic acid. In some examples, the thermoplastic resin may comprise a copolymer of ethylene and a monomer selected from methacrylic acid and acrylic acid.

In some examples, the polymer having acidic side groups is a copolymer of an alkylene monomer and a monomer selected from acrylic acid and methacrylic acid. In some examples, the thermoplastic resin may comprise a copolymer of an alkylene monomer and a monomer selected from acrylic acid and methacrylic acid.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt.% to about 25 wt.% of the copolymer, in some examples from 10 wt.% to about 20 wt.% of the copolymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise two different polymers having acidic side groups: a first polymer that is a copolymer of ethylene (e.g. 92 to 85 wt.%, in some examples about 89 wt.%) and acrylic or methacrylic acid (e.g. 8 to 15 wt.%, in some examples about 11 wt.%) having a melt flow rate of 80 to 110 g/10 minutes and a second polymer that is a copolymer of ethylene (e.g. about 80 to 92 wt.%, in some examples about 85 wt.%) and acrylic acid (e.g. about 18 to 12 wt.%, in some examples about 15 wt.%), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers.

The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt.% to about 16 wt.% of the copolymer, in some examples 10 wt.% to 16 wt.% of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt.% to about 30 wt.% of the copolymer, in some examples from 14 wt.% to about 20 wt.% of the copolymer, in some examples from 16 wt.% to about 20 wt.% of the copolymer in some examples from 17 wt.% to 19 wt.% of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples, from 65 to 90% by weight, from 65 to 80% by weight of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel 407™, Nucrel 609HS™ , Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201 , Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)).

In some examples, the resin may constitute 5% to 99% by weight of the total solids in the LEP ink composition, in some examples 50% to 90% by weight of the total solids of the LEP ink composition, in some examples 65% to 80% by weight of the total solids of the LEP ink composition. In some examples, the LEP ink composition may comprise resin in an amount of from 10% to 50% by weight of the total solids, for example, 15 % to 45 % by weight, 20% to 40% by weight, 25% to 35% by weight of the total solids.

### Colorant

The liquid electrophotographic ink composition may include a colorant. In some examples, the chargeable particles comprise a colorant. In some examples, the colorant may be a dye or pigment.

As used herein, “colorant” may be a material that imparts a colour to the ink composition. As used herein, “colorant” includes pigments and dyes, such as those that impart colours, such as black, magenta, cyan, yellow and white, to an ink. As used herein, “pigment” generally includes pigment colorants, magnetic particles, aluminas, silicas, and/or other ceramics or organometallics. Thus, though the present description primarily exemplifies the use of pigment colorants, the term “pigment” can be used more generally to describe not only pigment colorants, but also other pigments such as organometallics, ferrites, ceramics, and so forth.

In some examples, the colorant is selected from cyan colorants, magenta colorants, yellow colorants, black colorants, white colorants and silver colorants. In some examples, the colorant is selected from cyan pigments, magenta pigments, yellow pigments, black pigments, white pigments and silver pigments. In some examples, the colorant may be a white pigment or a silver pigment. In some examples, the colorant may be a white pigment.

The colorant can be any colorant compatible with the carrier liquid and useful for liquid electrophotographic printing. For example, the colorant may be present as pigment particles, or may comprise a resin as described herein and a pigment. The pigments can be any of those standardly used in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW 5GT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLlNG® NS BLACK, STERLlNG® NSX 76, MOGUL® L; pigments by DuPont including TIPURE® R-101; and pigments by Paul Uhlich including UHLICH® BK 8200. If the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment. If the pigment is a silver pigment, the pigment may be an aluminium powder.

The colorant may be present in the liquid electrophotographic ink composition in an amount of from 10 wt.% to 80 wt.% of the total amount of resin and pigment, in some examples, 15 wt.% to 80 wt.%, in some examples, 15 wt.% to 60 wt.%, in some examples, 15 wt.% to 50 wt.%, in some examples, 15 wt.% to 40 wt.%, in some examples, 15 wt.% to 30 wt.% of the total amount of resin and colorant. In some examples, the colorant or pigment particle may be present in an electrostatic ink composition in an amount of at least 50 wt.% of the total amount of resin and colorant or pigment, for example, at least 55 wt.% of the total amount of resin and colorant or pigment. In some examples, the liquid electrophotographic ink composition may be a transparent liquid electrophotographic ink composition that may comprise 0 wt.% colorant.

### Charge Adjuvant

In some examples, the LEP ink composition further includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co- methacrylic acid calcium and ammonium salts, copolymers of an alkyl acrylamidoglycolate alkyl ether (e.g., methyl acrylamidoglycolate methyl ether- co-vinyl acetate), or hydroxy bis(3,5-di-tert-butyl salicylic) aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.001% to 5% by weight, in some examples about 0.1% to 1% by weight, in some examples about 0.3% to 0.8% by weight of the total solids of the liquid electrostatic ink composition, in some examples, about 1 wt.% to 5 wt.% of the total solids of the liquid electrostatic ink, in some examples about 1 wt.% to 3 wt.% of the total solids of the liquid electrostatic ink composition, in some examples about 1.5 wt.% to 2.5 wt.% of the total solids of the liquid electrostatic ink composition.

The charge adjuvant may be present in an amount of less than 5% by weight of total solids of the liquid electrostatic ink composition, in some examples in an amount of less than 4.5% by weight, in some examples in an amount of less than 4% by weight, in some examples in an amount of less than 3.5% by weight, in some examples in an amount of less than 3% by weight, in some examples in an amount of less than 2.5% by weight, in some examples, in an amount of less than 2% by weight of the total solids of the liquid electrostatic ink composition.

In some examples, the liquid electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples a C14 to C22 fatty acid anion, in some examples a C16 to C20 fatty acid anion, in some examples a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt.% to 5 wt.% of the total solids of the liquid electrostatic ink composition, in some examples in an amount of 0.1 wt.% to 3 wt.% of the total solids of the liquid electrostatic ink composition, in some examples about 1 wt.% to 3 wt.% of the total solids of the liquid electrostatic ink composition, in some examples about 1.5 wt.% to 2.5 wt.% of the total solids of the liquid electrostatic ink composition.

### Charge Director

In some examples, the LEP ink composition further includes a charge director. In some examples, the carrier liquid is an aliphatic hydrocarbon and the LEP ink composition comprises a charge director. In some examples, the carrier liquid is an ester of a fatty acid and a monoalcohol and the LEP ink composition comprises a charge director. In some examples, the carrier liquid is an ester of a fatty acid and a monoalcohol and no charge director is used in the LEP ink composition.

The charge director may be added in order to impart and/or maintain sufficient electrostatic charge on the ink particles, which may be particles comprising the thermoplastic resin. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of a LEP ink composition.

In some examples, the liquid electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO3⁻, NO₃⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tertbutyl ammonium bromide, NH₄NO₃, LiTFA, Al₂(SO₄)₃, LiClO₄ and LiBF₄, or any sub-group thereof.

In some examples, the liquid electrostatic ink composition comprises a charge director comprising a sulfosuccinate salt of the general formula MAₙ, wherein M is a metal, n is the valence of M, and A is an ion of the general formula (I): [R¹-O-C(O)CH₂CH(SO₃⁻)-C(O)-O-R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01% to 10% by weight, in some examples 0.01% to 5% by weight of the total solids of a liquid electrostatic ink composition. In some examples, the charge director constitutes about 1% to 4% by weight of the total solids of the liquid electrostatic ink composition, in some examples 2% to 4% by weight of the total solids of the electrostatic ink composition.

In some examples, the charge director is present in an amount sufficient to achieve a particle conductivity of 500 pmho/cm or less, in some examples, 450 pmho/cm or less, in some examples, 400 pmho/cm or less, in some examples, 350 pmho/cm or less, in some examples, 300 pmho/cm or less, in some examples, 250 pmho/cm or less, in some examples, 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm. In some examples, the charge director is present in an amount sufficient to achieve a particle conductivity of 50 pmho/cm or more, in some examples, 60 pmho/cm or more, in some examples, 70 pmho/cm or more, in some examples, 80 pmho/cm or more, in some examples, 90 pmho/cm or more, in some examples, about 100 pmho/cm, in some examples, 150 pmho/cm or more, in some examples, 200 pmho/cm or more, in some examples, 250 pmho/cm or more, in some examples, 300 pmho/cm or more, in some examples, 350 pmho/cm or more, in some examples, 400 pmho/cm or more, in some examples, 450 pmho/cm or more, in some examples, 500 pmho/cm or more. In some examples, the charge director is present in an amount sufficient to achieve a particle conductivity of 50 pmho/cm to ycm, in some examples, 60 pmho/cm to 450 pmho/cm, in some examples/cm to 400 pmho/cm, in some examples, 80 pmho/cm to 350 pmho/cm, in some examples, 90 pmho/cm to 300 pmho/cm, in some examples, 100 pmho/cm to 250 pmho/cm, in some examples, 110 pmho/cm to 200 pmho/cm, in some examples, 120 pmho/cm to 500 pmho/cm, in some examples, 130 pmho/cm to 450 pmho/cm, in some examples, 140 pmho/cm to 400 pmho/cm, in some examples, 150 pmho/cm to 350 pmho/cm, in some examples, 160 pmho/cm to 300 pmho/cm.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the liquid electrostatic ink composition).

### Other Additives

The LEP ink composition may include another additive or a plurality of other additives. The other additive or plurality of other additives may be added at any stage of the method. The other additive or plurality of other additives may be selected from a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket. In some examples, the LEP ink composition comprises silica, which may be added, for example, to improve the durability of images produced using the LEP ink. The other additives may constitute 10 wt.% or less of the total solids of the electrostatic ink composition, in some examples, 5 wt.% or less of the total solids of the electrostatic ink composition, in some examples, 3 wt.% or less of the total solids of the electrostatic ink composition.

### Process for Producing an LEP Ink Composition

In another aspect, there is provided a process for producing a liquid electrophotographic ink composition. The process for producing a liquid electrophotographic ink composition may comprise: dispersing chargeable particles comprising a thermoplastic resin in a carrier liquid wherein the carrier liquid has been produced from vegetable oil or animal fat. The process for producing a liquid electrophotographic ink composition may comprise: dispersing chargeable particles comprising a thermoplastic resin in a carrier liquid wherein the carrier liquid has been produced from vegetable oil or animal fat and comprises an aliphatic hydrocarbon, an ester of a fatty acid and a monoalcohol or a mixture thereof. The process for producing a liquid electrophotographic ink composition may comprise dispersing chargeable particles comprising a thermoplastic rein in a carrier liquid comprising an aliphatic hydrocarbon, an ester of a fatty acid and a monoalcohol or a mixture thereof.

In some examples, the process for producing an LEP ink composition may comprise dispersing chargeable particles in a first carrier liquid to form a paste and then diluting the paste with a second carrier liquid to form the LEP ink composition. In some examples, the first carrier liquid is the same as or different from the second carrier liquid. In some examples, the first carrier liquid and/or the second carrier liquid comprises a carrier liquid producible from, for example, produced from, a vegetable oil or animal fat. In some examples, the first carrier liquid is producible from, for example, produced from, a vegetable oil or animal fat. In some examples, the second carrier liquid is producible from, for example, produced from, a vegetable oil or animal fat. In some examples, the first carrier liquid and the second carrier liquid is producible from, for example, produced from, vegetable oil or animal fat.

In some examples, the process for producing an LEP ink composition may comprise producing, from a vegetable oil, a carrier liquid comprising an aliphatic hydrocarbon, an ester of a fatty acid and a monoalcohol or a mixture thereof. In some examples, the process for producing an LEP ink composition may comprise producing, from a vegetable oil, a carrier liquid comprising an aliphatic hydrocarbon, an ester of a fatty acid and a monoalcohol or a mixture thereof, and then dispersing chargeable particles comprising a thermoplastic resin in the carrier liquid.

In some examples, an aliphatic hydrocarbon may be produced from a vegetable oil by high pressure hydrogenation.

In some examples, an ester of a fatty acid and a monoalcohol is produced from a vegetable oil by transesterification, for example, supercritical fluid transesterification, acid-catalysed transesterification, or enzyme-catalysed transesterification.

In some examples, the process of producing an LEP ink composition may comprise combining a thermoplastic resin and a colorant. In some examples, the process of producing an LEP ink composition may comprise combining a thermoplastic resin, a colorant and the carrier liquid.

In some examples, the process of producing a liquid electrophotographic ink composition may comprise combining a colorant and a thermoplastic resin. In some examples, the method of producing an LEP ink composition may comprise combining a colorant, a thermoplastic resin and a liquid carrier. In some examples, the process of producing an LEP ink composition may comprise combining a colorant with a liquid carrier before adding a thermoplastic resin.

In some examples, the thermoplastic resin is combined with a liquid carrier before addition of the colorant. In some examples, the thermoplastic resin is combined with a liquid carrier to form a first composition; the colorant is combined with a liquid carrier to form a second composition; and the first composition is combined with the second composition to form the LEP ink composition. In some examples, the liquid carrier in the first composition is the same or different from the liquid carrier in the second composition. In some examples, the liquid carrier in the first composition is the same as the liquid carrier in the second composition.

In some examples, the process of producing an LEP ink composition comprises adding a charge adjuvant to the LEP ink composition. In some examples, the charge adjuvant may be added to the LEP ink composition before, during or after the colorant and the thermoplastic resin are combined.

In some examples, the method of producing an LEP ink composition comprises adding a charge director to the LEP ink composition. In some examples, the charge director is added to the LEP ink composition before, during or after the charge adjuvant is added to the LEP ink composition. In some examples, the charge director may be added to the LEP ink composition before, during or after the colorant and the thermoplastic resin are combined.

In some examples, the method of producing an LEP ink composition may comprise suspending a thermoplastic resin in a carrier liquid before adding it to the colorant. In some examples, the method may comprise suspending a first thermoplastic resin and a second thermoplastic resin in a carrier liquid. In some examples, the LEP ink composition comprises chargeable particles comprising a first thermoplastic resin and a second thermoplastic resin. In some examples, the method of producing an LEP ink composition may comprise suspending chargeable particles comprising a first thermoplastic resin and a second thermoplastic resin in a carrier liquid.

In some examples, the method of producing an LEP ink composition may comprise dispersing a first thermoplastic resin and a second thermoplastic resin in a carrier liquid. In some examples, the method of producing an LEP ink composition may comprise dispersing chargeable particles comprising a first thermoplastic resin and a second thermoplastic resin in a carrier liquid.

In some examples, the method of producing an LEP ink composition may comprise combining a thermoplastic resin (for example, the first thermoplastic resin) with the carrier liquid and subsequently adding the other resin (for example, the second resin). In some examples, the method of producing an LEP ink composition comprises combining a resin (for example, the first resin) with the carrier liquid to form a paste and subsequently adding the other resin (for example, the second resin). In some examples, the resin and the carrier liquid are combined and heated to an elevated temperature before adding the other resin, which may have also been heated to an elevated temperature. In some examples, the resin and the carrier liquid are combined and heated to a temperature above the melting point of the resin before adding the other resin, which may have also been heated to a temperature above its melting point. In some examples, the resin and carrier liquid are combined and heated until the resin has melted and/or dissolved in the carrier liquid before adding the other resin. In some examples, adding the other resin to the combined resin and carrier liquid comprises mixing the other resin with the combined resin and carrier liquid.

The melting point of the resin may be determined by differential scanning calorimetry, for example, using ASTM D3418.

In some examples, the resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the resin. In some examples, the other resin is heated before being added to the combined resin and carrier liquid. In some examples, the other resin is heated to at least 30° C., in some examples, at least 40° C., in some examples, at least 45° C., in some examples, at least 50° C. before being added to the combined resin and carrier liquid. In some examples, the other resin is heated to 100° C. or less, in some examples, 90° C. or less, in some examples, 80° C. or less, in some examples, 75° C. or less, in some examples, 70° C. or less, in some examples, 60° C. or less before being added to the combined resin and carrier liquid. In some examples, the other resin is heated to reduce the viscosity of the other resin before being added to the first resin and the carrier liquid.

In some examples, the method comprises combining the first resin with the carrier liquid to form a first composition; combining the second resin with the carrier liquid to form a second composition; and subsequently combining the first composition and the second composition to form a liquid electrophotographic ink composition. In some examples, the method comprises combining the first resin with the carrier liquid to form a first paste; combining the second resin with the carrier liquid to form a second paste; and subsequently combining the first paste and the second paste to form a liquid electrophotographic ink composition. In some examples, the first resin and the carrier liquid are combined and heated to an elevated temperature to form a first heated composition; the second resin and the carrier liquid are combined and heated to an elevated temperature to form a second heated composition; and subsequently the first heated composition and the second heated composition are combined. In some examples, the first resin and the carrier liquid are combined and heated to a temperature above the melting point of the first resin to form a first heated composition; the second resin and the carrier liquid are combined and heated to a temperature above the melting point of the second resin to form a second heated composition; and subsequently the first heated composition and the second heated composition are combined. In some examples, the first composition and the second composition are heated to the same temperature, which may be a temperature above the melting temperature of all of the resins.

In some examples, the method of producing an LEP ink composition comprises mixing the first resin and the second resin together and then combining the mixture of the resins with the carrier liquid.

In some examples, the first resin and the second resin are combined with the carrier liquid and subsequently heated to an elevated temperature. In some examples, the first resin and the second resin are combined with the carrier liquid and subsequently heated to a temperature above the melting point of at least one, optionally all, of the resins. In some examples, the first resin and the second resin are combined with the carrier liquid and subsequently heated to a temperature of at least 70° C., for example, at least 80° C., for example, at least 90° C., for example, at least 100° C., for example, at least 110° C., for example, at least 120° C., for example, 130° C., for example, to melt at least one, optionally all, of the resins. In some examples, the combined first resin, second resin and carrier liquid are heated until all of the resins have melted and/or dissolved in the carrier liquid.

In some examples, the method of producing a liquid electrophotographic ink composition comprises combining a first resin, a second resin, and a carrier liquid.

In some examples, the chargeable particles comprise the first resin and the second resin.

Melting and/or dissolving a resin (or resins) in the carrier liquid may result in the carrier fluid appearing clear and homogeneous. In some examples, the resin (or resins) and carrier liquid are heated before, during or after mixing.

In some examples, the resin (or resins) and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the resin (or resins) in the carrier liquid is complete.

In some examples, after combining and heating the resins and the carrier liquid, the mixture is cooled to a temperature below the melting point of the resins, for example, to room temperature. In some examples, the chargeable particles are removed from the carrier liquid and re-dispersed in a new portion of carrier liquid, which may be the same or a different carrier liquid.

In some examples, the method of producing an LEP ink composition comprises adding a colorant to the combined first resin, second resin and carrier liquid. In some examples, the method of producing an LEP ink composition comprises adding a colorant to the combined first resin, second resin and carrier liquid to form chargeable particles comprising the resins and a colorant. In some examples, the method of producing an LEP ink composition comprises grinding the colorant and the resins in the presence of the carrier liquid to form a paste. In some examples, the method of producing an LEP ink composition comprises heating and mixing the colorant and the resins in the presence of the carrier liquid to form a paste.

In some examples, the method of producing an LEP ink composition comprises adding a charge adjuvant to the combined first resin, second resin and carrier liquid and optionally grinding. In some examples, the method of producing an LEP ink composition comprises adding a charge adjuvant and a colorant to the combined first resin, second resin and carrier liquid and optionally grinding. In some examples, the method of producing an LEP ink composition comprises adding a charge adjuvant to the combined first resin, second resin, colorant and carrier liquid and optionally grinding.

In some examples, the method of producing an LEP ink composition comprises grinding at a grinding speed of at least 50 rpm. In some examples, the method of producing an LEP ink composition comprises grinding at a grinding speed of up to about 600 rpm. In some examples, the method of producing an LEP ink composition comprises grinding for at least 1 h, in some examples, for at least 2 h. In some examples, the method of producing an LEP ink composition comprises grinding for up to about 12 h. In some examples, the method of producing an LEP ink composition comprises grinding at a temperature of at least about 30° C., for example, at least about 35° C., for example, at least about 40° C., for example, at least about 50° C. In some examples, the method of producing an LEP ink composition comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

In some examples, the method of producing an LEP ink composition comprises adding a charge director to the combined first resin, second resin and carrier liquid. In some examples, the method of producing an LEP ink composition comprises adding a charge director to the combined first resin, second resin, colorant and carrier liquid. In some examples, the method of producing an LEP ink composition comprises adding a charge director to the combined first resin, second resin, charge adjuvant and carrier liquid. In some examples, the method of producing an LEP ink composition comprises adding a charge director to the combined first resin, second resin, colorant, charge adjuvant and carrier liquid.

### LEP Printing Process

In a further aspect, there is provided a liquid electrophotographic printing process. The liquid electrophotographic printing process may comprise: electrophotographically printing a liquid electrophotographic ink composition comprising chargeable particles comprising a thermoplastic resin and a carrier liquid produced from vegetable oil or animal fat. The liquid electrophotographic printing process may comprise: electrophotographically printing a liquid electrophotographic ink composition comprising chargeable particles comprising a thermoplastic resin and a carrier liquid produced from vegetable oil or animal fat, the carrier liquid comprising an aliphatic hydrocarbon, an ester of a fatty acid and a monoalcohol or a mixture thereof. The liquid electrophotographic printing process may comprise: electrophotographically printing a liquid electrophotographic ink composition comprising chargeable particles comprising a thermoplastic resin and a carrier liquid comprising an aliphatic hydrocarbon, an ester of a fatty acid and a monoalcohol or a mixture thereof.

LEP printing may comprise forming a latent electrostatic image on a surface of a photoimaging plate, contacting an LEP ink composition with the surface such that at least some of the chargeable particles of the LEP ink composition adhere to the surface to form a developed image on the surface, and transferring the developed image to a target substrate, optionally via an intermediate transfer member (ITM).

In some examples, the ITM may be heated. In some examples, the ITM may be heated to a temperature of at least 80° C. In some examples, the ITM may be heated to a temperature of at least 85° C., for example, at least 90° C., at least 95° C., at least 100° C., at least 105° C., at least 110° C., at least 115° C., at least 120° C., at least 125° C., at least 130° C., at least 135° C., at least 140° C., at least 145° C., at least 150° C., at least 155° C., at least 160° C., at least 165° C., at least 170° C., at least 175° C., at least 180° C., at least 185° C., at least 190° C., or at least 195° C. In some examples, the ITM may be heated to a temperature of up to 200° C., for example, up to 195° C., up to 190° C., up to 185° C., up to 180° C., up to 175° C., up to 170° C., up to 165° C., up to 160° C., up to 155° C., up to 150° C., up to 145° C., up to 140° C., up to 135° C., up to 130° C., up to 125° C., up to 120° C., up to 115° C., up to 110° C., up to 105° C., up to 100° C., up to 95° C., up to 90° C., up to 85° C. In some examples, the ITM may be heated to a temperature of from 80° C. to 200° C., for example, 85° C.°C to 195° C., 90° C. to 190° C., 95° C. to 185° C., 100° C. to 175° C., 105° C. to 170° C., 110° C. to 165° C., 115° C. to 160° C., 120° C. to 155° C., 125° C. to 150° C., 130° C. to 145° C., 135° C. to 140° C. In some examples, the ITM is heated to evaporate at least some of the carrier liquid. In some examples, at least some of the carrier liquid is removed during the electrophoresis that is used to transfer of the chargeable particles from the photoimaging plate to the ITM.

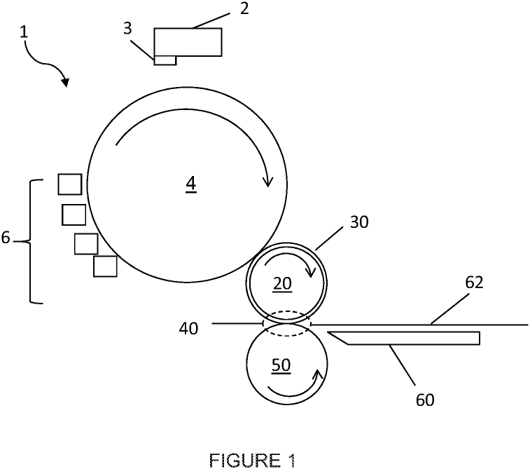

In some examples, the LEP printing is performed by a liquid electrophotographic printer. FIG. 1 shows a schematic illustration of an example of an LEP printing apparatus 1 comprising an intermediate transfer member. An image, including any combination of graphics, text and images, is communicated to the LEP printing apparatus 1. The LEP printing apparatus includes a photo charging unit 2 and a photo-imaging cylinder 4. The image is initially formed on a photoimaging plate (also known as a photoconductive member), in this case in the form of photo-imaging cylinder 4, before being transferred to a release layer 30 of the intermediate transfer member (ITM) 20 which is in the form of a roller (first transfer, T1), and then from the release layer 30 of the ITM 20 to a print substrate 62 (second transfer, T2).

According to an illustrative example, the initial image is formed on rotating a photo-imaging cylinder 4 by a photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to the photo-imaging cylinder 4 by a binary ink developer (BID) unit 6. The BID unit 6 presents a uniform film of liquid electrophotographic ink to the photo-imaging cylinder 4. The liquid electrophotographic ink contains electrically charged particles which, by virtue of an appropriate potential on the electrostatic image areas, are attracted to the latent electrostatic image on the photo-imaging cylinder 4. The liquid electrophotographic ink does not adhere to the uncharged, non-image areas and forms a developed toner image on the surface of the latent electrostatic image. The photo-imaging cylinder 4 then has a single colour ink image on its surface.

The developed toner image is then transferred from the photo-imaging cylinder 4 to a release layer 30 of an ITM 20 by electrical forces. The image is then dried and fused on the release layer 30 of the ITM 20 before being transferred from the release layer 30 of the ITM 20 to a print substrate 62 disposed on an impression cylinder 50. The process may then be repeated for each of the coloured ink layers to be included in the final image.

The image is transferred from a photo-imaging cylinder 4 to an ITM 20 by virtue of an appropriate potential applied between the photo-imaging cylinder 4 and the ITM 20, such that the charged ink is attracted to the ITM 20.

Between the first and second transfers, the solid content of the developed toner image is increased and the ink is fused on to the ITM 20. For example, the solid content of the developed toner image deposited on the cured silicone release layer 30 after the first transfer is typically around 20%, by the second transfer the solid content of the developed toner image is typically around 80-90%. This drying and fusing is typically achieved by using elevated temperatures and airflow-assisted drying. In some examples, the ITM 20 is heatable.

The print substrate 62 is fed into the printing apparatus by a print substrate feed tray 60 and is disposed on an impression cylinder 50. As the print substrate 62 contacts the ITM 20, the single colour image is transferred to the print substrate 62.

To form a single colour image (such as a black and white image), one pass of the print substrate 62 through the impression cylinder 50 and the ITM 20 completes the image. For a multiple colour image, the print substrate 62 may be retained on the impression cylinder 50 and make multiple contacts with the ITM 20 as it passes through the nip 40. At each contact an additional colour plane may be placed on the print substrate 62.

In some examples, the LEP ink composition comprises an ester of a fatty acid and a monoalcohol and no charge director is required to induce a charge on the chargeable particles in the LEP ink composition.

The LEP printing process may produce a printed substrate. The printed substrate may comprise a print substrate and an LEP ink composition disposed on the print substrate. In some examples, the printed substrate may comprise a primer disposed between the print substrate and the LEP ink composition.

### Print Substrate

In some examples, the print substrate may be any suitable substrate. In some examples, the print substrate may be any suitable substrate capable of having an image printed thereon. The print substrate may include a material selected from an organic or inorganic material. The material may include a natural polymeric material, for example, cellulose. The material may include a synthetic polymeric material, for example, a polymer formed from alkylene monomers, including, but not limited to, polyethylene, polypropylene, and co-polymers such as styrene-polybutadiene. The polypropylene may, in some examples, be biaxially oriented polypropylene. The material may include a metal, which may be in sheet form. The metal may be selected from or made from, for instance, aluminium (Al), silver (Ag), tin (Sn), copper (Cu) and mixtures thereof. In an example, the print substrate includes a cellulosic paper. In an example, the cellulosic paper is coated with a polymeric material, for example, a polymer formed from styrene-butadiene resin. In some examples, the cellulosic material has an inorganic material bound to its surface (before printing with ink) with a polymeric material, wherein the inorganic material may be selected from, for example, kaolinite or calcium carbonate. In some examples, the print substrate is a cellulosic substrate such as paper. In some examples, the cellulosic substrate may be a coated cellulosic substrate. In some examples, a primer may be coated onto the print substrate before the electrophotographic ink composition is printed onto the print substrate.

In some examples, the print substrate may be a plastic film. In some examples, the print substrate may be any plastic film capable of having an image printed thereon. The plastic film may include a synthetic polymeric material, for example, a polymer formed from alkylene monomers, including, for example, polyethylene and polypropylene, and co-polymers such as styrene-polybutadiene polymers. The polypropylene may, in some examples, be biaxially orientated polypropylene. In some examples, the plastic film may comprise polyethylene terephthalate.

In some examples, the plastic film is a thin film. In some examples, the plastic film comprises polyethylene (PE), linear low density polyethylene (LLDPE), low density polyethylene (LDPE), medium density polyethylene (MDPE), high density polyethylene (HDPE), polypropylene (PP), cast (cPP) or biaxially oriented polypropylene (BOPP), oriented polyamide (OPA), or polyethylene terephthalate (PET).

In some examples, the print substrate comprises a plurality of layers of material laminated together to form a pre-laminated substrate. In some examples, the print substrate comprises a plurality of layers of material laminated together to form a pre-laminated substrate in which a plastic film forms the surface onto which electrophotographic ink can be applied. In some examples, the print substrate comprises a plurality of layers of film laminated together to form a pre-laminated substrate in which a plastic film forms the surface onto which liquid electrophotographic ink can be applied. In an example, the print substrate may be a plastic film laminated to, adhered to or coated on a cellulosic paper. In some examples, the print substrate comprises a plurality of layers of material selected from polymeric materials (e.g. polymeric materials selected from PE, LLDPE, MDPE, PP, BOPP, PET and OPA), metallic materials (e.g. metallic foils such as aluminium foil, or metallized films such as met-PET, met-BOPP or any other metalized substrate), paper and combinations thereof. In some examples, the print substrate comprises a plurality of layers of film of a plastic material, such as a combination of films selected from PE, LLDPE, MDPE, PP, BOPP, PET and OPA, laminated together to form the pre-laminated substrate. In some examples, the pre-laminated substrate comprises a Paper/Alu/PE, PET/AI/PE, BOPP/met-BOPP or PET/PE laminate.

### EXAMPLES

The following illustrates examples of the methods and other aspects described herein. Thus, these Examples should not be considered as limitations of the present disclosure, but are merely in place to teach how to make examples of the present disclosure.

### Materials

### Carrier Liquid

Scriptane Biolife 25/27: a mixture of aliphatic hydrocarbons comprising C15 and C16 hydrocarbons produced from palm oil with a boiling point range of 247° C. to 269° C., which contains less than 0.005 wt.% aromatic compounds (available from Total™).

Methyl octanoate: an ester of octanoic acid and methanol derived from coconut/palm oil, with a boiling point of 193° C., which contains 0 wt.% aromatic compounds (available from Procter & Gamble).

Methyl decanoate: an ester of decanoic acid and methanol derived from coconut/palm oil, with a boiling point of 224° C., which contains 0 wt.% aromatic compounds (available from Procter & Gamble).

Isopropyl laurate: an ester of lauric acid (dodecanoic acid) and isopropanol derived from coconut/palm oil, with a boiling point of 281° C., which contains 0 wt.% aromatic compounds (available from Oleon).I

Isopar L: a petroleum-based isoparaffinic oil comprising a mixture of C11-C13 isoalkanes with a boiling point range of 190° C. to 208° C., which contains less than 2 wt.% aromatic compounds (produced by Exxon Mobil™; CAS number 64742-48-9).

### Thermoplastic Resin

Nucrel® 699: a copolymer of ethylene and methacrylic acid, made with nominally 11 wt.% methacrylic acid (available form DuPont).

AC-5120: a copolymer of ethylene and acrylic acid with an acrylic acid content of 15 wt.% (available from Honeywell).

### Charge Adjuvant

VCA: an aluminium stearate (available from Fischer Scientific).

### Charge Director

HP Imaging Agent: Q4321A, for use with WS6000 and 7000 printing presses.

### Example 1

Magenta ElectroInk™ 4.5 paste with a non-volatile solids content of about 24 wt.% comprising a resin (a 4:1 mixture of Nucrel™ 699 and A-C 5120), magenta pigment, VCA as the charge adjuvant and Isopar™ L was provided. The LEP paste was diluted with Scriptane Biolife™ 25/27 as the liquid carrier to form an LEP ink composition with a non-volatile solids content of 2.3 wt.%. Thus, the LEP ink composition contained Scriptane Biolife 25/27 in an amount of 90 wt.% of the total weight of the LEP ink composition and Isopar™ L in an amount of 7.7 wt.% of the total weight of the LEP ink composition. Prior to printing, a charge director was added in an amount of 0.96 wt.% of the total weight of the LEP ink composition.

### Example 2

A magenta LEP ink composition was prepared as in Example 1 except that methyl decanoate was used instead of Scriptane Biolife™ 25/27. The LEP ink composition was produced by combining 1 part Magenta ElectroInk™ 4.5 paste with 9 parts methyl decanoate, producing an LEP ink composition containing 2.6 wt.% NVS. No charge director was added to this composition prior to printing.

### Reference Example

A magenta LEP ink composition was prepared as in Example 1 except that Isopar™ L was used instead of Biolife™ 25/27. Thus, the LEP ink composition contained 3.3 wt.% NVS and Isopar™ in an amount of 96.7 wt.% of the total weight of the LEP ink composition.

### Results

The high and low field conductivities of liquid electrophotographic ink compositions according to Examples 1 and 2 and the Reference Example are shown in Table 1.

TABLE 1

| | NVS [wt.%] | Isopar L [wt.%] | Carrier liquid produced from vegetable oil [wt.%] | | HF conductivity [pS/cm] | LF conductivity [pS/cm] |
|---|---|---|---|---|---|---|
| Ref. Ex. | 3.3 | 96.7 | - | 0 | 199 | 60 |
| Ex. 1 | 2.3 | 7.7 | Scriptane Biolife 25/27 | 90 | 112 | 59 |
| Ex. 2 | 2.6 | 7.4 | Methyl decanoate | 90 | 265 | 70 |

### High and Low Field Conductivity

The low field (LF) conductivity was measured using a low field probe and the high field (HF) conductivity was measured by a Q/M device that measures electrophoretic conductivity at high filed. The LEP ink composition was placed between two electrodes (spaced apart by about 1 mm, with an area of 100 mm²). To measure the high field conductivity, an electric field of about 1500 V/mm was applied and the current measured. The high field conductivity was calculated by extrapolating the conductivity to time=0. The low field conductivity was calculated by applying a voltage of about 1 V/mm and measuring the current.

Additionally, the HF and LF conductivities were also measured for LEP ink compositions comprising 1 part magenta ElectroInk 4.5 paste diluted with 7 parts of the liquid carrier (Table 2).

TABLE 2

| | | b.p. [°C] | HF [pS/cm] | LF [pS/cm] |
|---|---|---|---|---|
| Isopar L | CₙH₂ₙ₊₂, n=11-13 | 190-208 | 68 | 11 |
| Scriptane Biolife 25/27 | CₙH₂ₙ₊₂, n=15-16 | 247-269 | 27 | 7 |
| Methyl octanoate | C₉H₁₈O₂ | 193 | 827 | 341 |
| Methyl decanoate | C₁₁H₂₂O₂ | 224 | 373 | 115 |
| Isopropyl laurate | C₁₅H₃₀O₂ | 281 | 118 | 28 |

The HF and LF conductivities shown in Table 2 differ from those in Table 1 because the concentration of the LEP ink compositions is different.

### Printing Tests

The Example 1 ink composition was printed using an HP Indigo 7500 LEP printer. The images were produced using the same printer settings as are used for current ElectroInk™ 4.5 LEP ink compositions (V_developer = 445 V, V_Electrode = 1452 V, V_Squeegee= 813 V, and V_light=72 V. The LEP printer included an ITM blanket that had been used for ~14 K impressions, a photoimaging plate that had been used for ~7 K impressions, and a magenta binary ink developer (BID) had been used for ~7 K impressions.

An optical density of 1.37 was produced without calibrating the machine for the new ink composition (the Reference Example ink provides an optical density of 1.5). The higher boiling point of the liquid carrier (with a midpoint of 258° C. vs the midpoint for Isopar L of 198° C.) means that after about 10 prints some ink (mainly single dots) was retained on the ITM blanket rather than being transferred to the print medium. A single cleaning page removed this ink from the ITM blanket. When viewed under an optical microscope, isolated small dots may show a reduced intensity. Nevertheless, immediately after printing, the images appear dry and resist rubbing with a fingertip, although scratching with a fingernail results in damage to the images. It is believed that these issues would be overcome by increasing the temperature of the ITM blanket to about 150° C. (rather than the 100° C. used for the test print run).

The Example 2 ink composition was tested in a Q/M instrument by using an applied field of 1500 V/mm. The Q/M instrument is an electrodeposition instrument in which the LEP ink is placed between two electrodes and a high voltage is applied to deposit the ink on a substrate located near one of the electrodes. This showed that even with no charge director present in the Example 2 LEP ink composition the magenta chargeable particles were collected/developed on one electrode, with no magenta chargeable particles collected on the other electrode. Without wishing to be bound by theory, it is believed that the ester group of the methyl decanoate molecules exchanges charge with the chargeable particles of the LEP ink. Furthermore, it is believed that an ITM blanket temperature of 135° C. would provide excellent printing results on an LEP printer.

### Optical Density

The optical density (OD) of the LEP ink composition on the printed substrates was measured by using an optical densitometer from X-rite™.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims and their equivalents. Unless otherwise stated, the features of any dependent claim can be combined with the features of any of the other dependent claims and any of the independent claims.

1. A liquid electrophotographic ink composition comprising:
chargeable particles comprising a thermoplastic resin; and
a carrier liquid produced from vegetable oil or animal fat, the carrier liquid comprising an aliphatic hydrocarbon, an ester of a fatty acid and a monoalcohol or a mixture thereof.

2. The liquid electrophotographic ink composition of claim 1, wherein the carrier liquid produced from vegetable oil or animal fat comprises up to about 0.005 wt.% aromatic compounds.

3. The liquid electrophotographic ink composition of claim 1, wherein the ester of a fatty acid and a monoalcohol is selected from C5 to C25 esters of a fatty acid and a monoalcohol and mixtures thereof.

4. The liquid electrophotographic ink composition of claim 1, wherein the monoalcohol is selected from C1 to C5 monoalcohols and mixtures thereof.

5. The liquid electrophotographic ink composition of claim 1, wherein the fatty acid is selected from C5 to C24 fatty acids and mixtures thereof.

6. The liquid electrophotographic ink composition of claim 1, wherein the ester of a fatty acid and a monoalcohol is selected from methyl octanoate, methyl decanoate and isopropyl laurate.

7. The liquid electrophotographic ink composition of claim 1, wherein the aliphatic hydrocarbon is selected from C5 to C25 aliphatic hydrocarbons and mixtures thereof.

8. The liquid electrophotographic ink composition of claim 1, wherein the carrier liquid has a boiling point or a boiling range within the range of from 150° C. to 300° C., for example, 250° C. to 300° C.

9. The liquid electrophotographic ink composition of claim 1, wherein the carrier liquid is produced from a vegetable oil selected from palm oil, coconut oil, soybean oil, rapeseed oil, coffee bean oil, sunflower oil, used cooking oil and mixtures thereof.

10. A process for producing a liquid electrophotographic ink composition comprising: dispersing chargeable particles comprising a thermoplastic resin in a carrier liquid wherein the carrier liquid has been produced from vegetable oil or animal fat and comprises an aliphatic hydrocarbon, an ester of a fatty acid and a monoalcohol or a mixture thereof.

11. The process for producing a liquid electrophotographic ink composition of claim 10, comprising producing, from a vegetable oil or animal fat, an aliphatic hydrocarbon, an ester of a fatty acid and a monoalcohol or a mixture thereof.

12. The process for producing a liquid electrophotographic ink composition of claim 10, wherein the aliphatic hydrocarbon is produced from vegetable oil or animal fat by high pressure hydrogenation and the ester of a fatty acid and a monoalcohol is produced from vegetable oil or animal fat by transesterification.

13. A liquid electrophotographic printing process comprising:
electrophotographically printing a liquid electrophotographic ink composition comprising chargeable particles comprising a thermoplastic resin; and a carrier liquid produced from vegetable oil or animal fat, the carrier liquid comprising an aliphatic hydrocarbon, an ester of a fatty acid and a monoalcohol or a mixture thereof.

14. The liquid electrophotographic printing process according to claim 13, wherein no charge director is added to the liquid electrophotographic ink composition.

15. The liquid electrophotographic printing process according to claim 13, wherein the intermediate transfer member (ITM) of the liquid electrophotographic printer is heated to a temperature of at least 130° C. to evaporate the carrier liquid produced from vegetable oil or animal fat.
